(19) United States
(12) Patent Application Publication
(10) Pub. No.: US 2026/0238101 A1
(43) Pub. Date: Aug. 13, 2026

(54) ELECTROMAGNETIC REACTION WHEEL

(71) Applicant: National Tsing Hua University, Hsinchu City (TW)

(72) Inventors: Kuo-Ching Liu, Hsinchu City (TW); Jen-Yuan Chang, Hsinchu City (TW)

(73) Assignee: National Tsing Hua University, Hsinchu City (TW)

(21) Appl. No.: 19/083,449

(22) Filed: Mar. 19, 2025

(30) Foreign Application Priority Data
Feb. 11, 2025 (TW) 114105034

(51) Int. Cl. H02K 19/04; B64G 1/28

(52) U.S. Cl. CPC H02K 19/04; B64G 1/283

(57) ABSTRACT

An electromagnetic reaction wheel includes an annular tube, a plurality of coil assemblies, a magnetic assembly, and a control unit. The annular tube has a chamber. Each of the plurality of coil assemblies includes a plurality of first coils and a plurality of second coils. The plurality of first coils are disposed on an outer surface of the annular tube. The plurality of second coils are distant from the annular tube. The plurality of first coils and the plurality of second coils are arranged in Halbach array sequence. The magnetic assembly is movably disposed in the chamber of the annular tube. The control unit is electrically connected to the coil assemblies and is adapted to control the plurality of first coils and/or the plurality of second coils to be energized or de-energized, so as to drive the magnetic assembly to move relative to the annular tube in the chamber.

### CROSS-REFERENCE TO RELATED APPLICATION

This application claims the priority benefit of Taiwan application serial no. 114105034, filed on Feb. 11, 2025. The entirety of the above-mentioned patent application is hereby incorporated by reference herein and made a part of this specification.

### BACKGROUND

### Technical Field

The disclosure relates to a reaction wheel, and particularly relates to an electromagnetic reaction wheel.

### Description of Related Art

A reaction wheel is a device primarily employed in spacecrafts such as satellites. A reaction wheel typically includes a motor, a flywheel, and bearings. In the conventional reaction wheel, the flywheel is driven by the motor to rotate, so as to generate angular momentum. This induced angular momentum results in a reaction force on the satellite, leads to an opposite movement of the satellite, and thus achieves attitude adjustment for the satellite in the space environment. However, long-term operation inevitably leads to bearing wear in conventional reaction wheels. Such wear may lead to problems such as structural vibration, operational instability, and diminished control precision, potentially culminating in satellite malfunction. Therefore, the development of a new reaction wheel exhibiting great operational stability and extended lifespan has become an urgent need for ensuring mission success.

### SUMMARY

The disclosure provides an electromagnetic reaction wheel that has excellent operational stability and extended lifespan.

An electromagnetic reaction wheel of the disclosure includes an annular tube, a plurality of coil assemblies, a magnetic assembly, and a control unit. The annular tube has a chamber. Each of the plurality of coil assemblies includes a plurality of first coils and a plurality of second coils. The plurality of first coils are disposed on an outer surface of the annular tube. The plurality of second coils are distant from the annular tube. The plurality of first coils and the plurality of second coils are arranged in Halbach array sequence. The magnetic assembly is movably disposed in the chamber of the annular tube. The control unit is electrically connected to the coil assemblies. The control unit is adapted to control the plurality of first coils and/or the plurality of second coils to be energized or de-energized, so as to drive the magnetic assembly to move relative to the annular tube in the chamber.

In an embodiment of the disclosure, the plurality of second coils are disposed between a center of the annular tube and the annular tube.

In an embodiment of the disclosure, the plurality of first coils include two first coils, and the plurality of second coils are located between the two first coils.

In an embodiment of the disclosure, the plurality of first coils and the plurality of second coils are arranged along a virtual arc line.

In an embodiment of the disclosure, the electromagnetic reaction wheel further includes a core body. The core body is made of soft magnetic material and passes through the plurality of second coils.

In an embodiment of the disclosure, the electromagnetic reaction wheel further includes a plurality of core bodies. The plurality of core bodies are made of soft magnetic material and are respectively disposed inside the plurality of second coils.

In an embodiment of the disclosure, the magnetic assembly includes two magnetic pole groups. Each of the two magnetic pole groups includes a first magnetic pole and a second magnetic pole being opposite in magnetic polarity. The first magnetic pole and the second magnetic pole are arranged along a first direction. The first magnetic pole of each of the two magnetic pole groups is distant from each other, and the second magnetic pole of each of the two magnetic pole groups is adjacent to each other.

In an embodiment of the disclosure, the magnetic assembly includes two magnet groups. Each of the two magnet groups includes a plurality of magnets. The plurality of magnets are arranged in Halbach array sequence. A strong side of each of the two magnet groups is distant from each other, and a weak side of each of the two magnet groups is adjacent to each other.

In an embodiment of the disclosure, the plurality of second coils include at least three second coils.

In an embodiment of the disclosure, the plurality of coil assemblies comprise at least three coil assemblies.

In summary, the electromagnetic reaction wheel of the disclosure includes an annular tube, a plurality of coil assemblies, a magnetic assembly, and a control unit. The first coils and the second coils in each of the coil assemblies are arranged in Halbach array sequence to generate a magnetic field with a direction along the circumference of the annular tube. By appropriately controlling the first coils and/or the second coils to be energized or deenergized, the control unit may drive the magnetic assembly to move smoothly relative to the annular tube in the chamber of the annular tube, thereby enabling appropriate angular momentum generation and effective attitude adjustment of the host spacecraft such as a satellite. The elimination of structures such as a flywheel and bearings in the electromagnetic reaction wheel avoids issues associated with bearing wear, thereby providing an extended operational lifespan and enhanced operational stability.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view of an electromagnetic reaction wheel according to an embodiment of the disclosure.

FIG. 2 is another schematic view of the electromagnetic reaction wheel of FIG. 1.

FIG. 3 is a partially enlarged schematic view of the electromagnetic reaction wheel of FIG. 1.

FIG. 4 is a partially enlarged schematic view of the electromagnetic reaction wheel of FIG. 3.

FIG. 5 is a schematic view of a magnetic assembly according to another embodiment of the disclosure.

FIG. 6 is a partially enlarged schematic view of an electromagnetic reaction wheel according to another embodiment of the disclosure.

FIG. 7 is a partially enlarged schematic view of an electromagnetic reaction wheel according to another embodiment of the disclosure.

### DESCRIPTION OF THE EMBODIMENTS

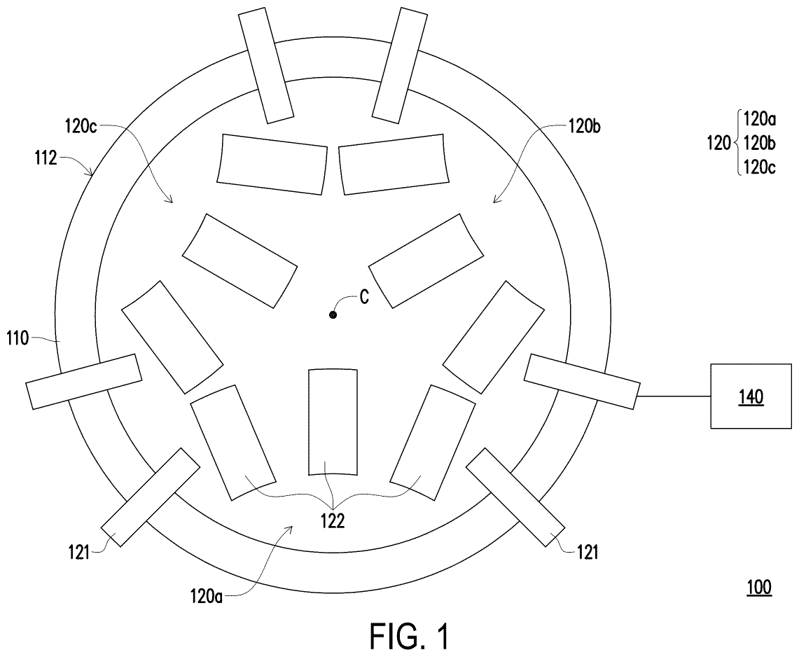

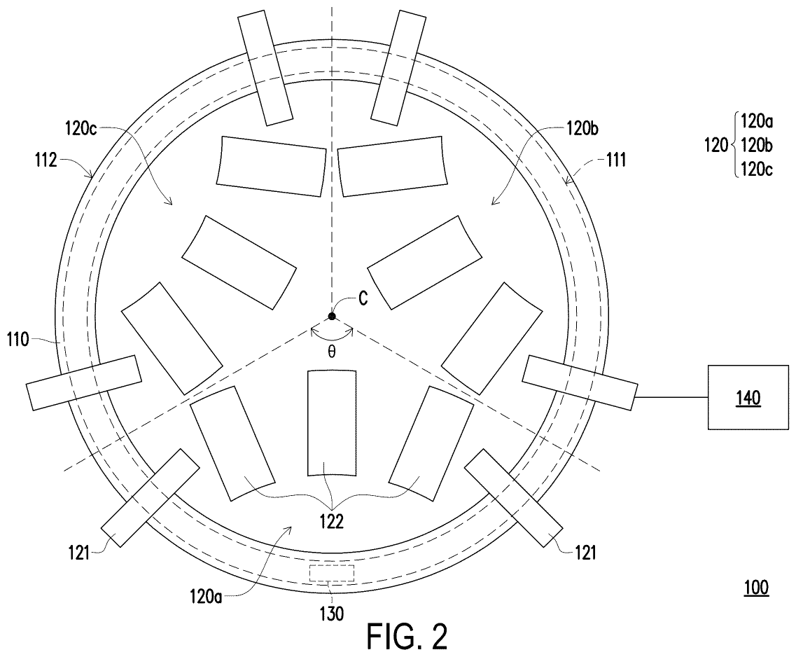

FIG. 1 is a schematic view of an electromagnetic reaction wheel according to an embodiment of the disclosure. FIG. 2 is another schematic view of the electromagnetic reaction wheel of FIG. 1. Note that the chamber 111 and the magnetic assembly 130 in FIG. 2 are schematically drawn with dotted lines.

Referring to FIG. 1 and FIG. 2, the electromagnetic reaction wheel 100 in this embodiment may be disposed in a spacecraft such as a CubeSat (whose unit dimensions are 10 cm*10 cm*10 cm, with the unit weight approximately 1.33 kg), and may generate appropriate angular momentum to effectively adjust the attitude of the spacecraft in the space environment. Specifically, the electromagnetic reaction wheel 100 includes an annular tube 110, a plurality of coil assemblies 120, a magnetic assembly 130 (FIG. 2), and a control unit 140.

The annular tube 110 has a chamber 111 (FIG. 2) circumferentially disposed inside the annular tube 110. The annular tube 110 must be capable of withstanding the rigors of extreme environments, such as those encountered in space. The material of the annular tube 110 is, for example, PFA (Perfluoroalkoxy alkane), providing great weather resistance and chemical stability, but the material of the annular tube 110 is not limited thereto.

The plurality of coil assemblies 120 include at least three coil assemblies 120, so as to generate a magnetic field that covers the entirety of the annular tube 110. As illustrated in FIG. 2, the plurality of coil assemblies 120 in this embodiment includes three coil assemblies 120a, 120b, and 120c. The angle θ of each of the coil assemblies 120a, 120b, 120c is defined as the central angle of the annular tube 110 corresponding to the distribution range of the specific coil assembly. In this embodiment, the angle θ of each of the coil assemblies 120a, 120b, 120c is equal to or approximately 120 degrees.

In another embodiment, the plurality of coil assemblies 120 includes four coil assemblies, and the angle θ of each of the coil assemblies 120 is equal to or approximately 90 degrees. Note that the more the number of coil assemblies 120 is, the greater the magnetic field intensity will be, but this also leads to an increase in overall weight. Preferably, the number of coil assemblies 120 is three.

Each of the coil assemblies 120a, 120b, 120c includes a plurality of first coils 121 and a plurality of second coils 122. Taking the coil assembly 120a as an example, the first coils 121 of the coil assembly 120a are disposed on an outer surface 112 of the annular tube 110, and the second coils 122 are distant from the annular tube 110. More specifically, the plurality of first coils 121 includes two first coils 121, the two first coils 121 are disposed at an interval, and the angle θ corresponding to the distribution of the two first coils 121 does not exceed 120 degrees.

The plurality of second coils 122 include at least three second coils 122, so as to ensure sufficient magnetic field intensity and magnetic gradient of the overall magnetic field. In this embodiment, the second coils 122 include three second coils 122, but the number of the second coils 122 is not limited thereto. The second coils 122 are located between the two first coils 121 and are disposed between the center C of the annular tube 110 and the outer surface 112 of the annular tube 110. That is, the second coils 122 is disposed near the inner side of the annular tube 110.

In this embodiment, the first coils 121 and the second coils 122 are made of copper or aluminum alloy that has great electrical conductivity, but the material of the first coils 121 and the material of the second coils 122 are not limited thereto.

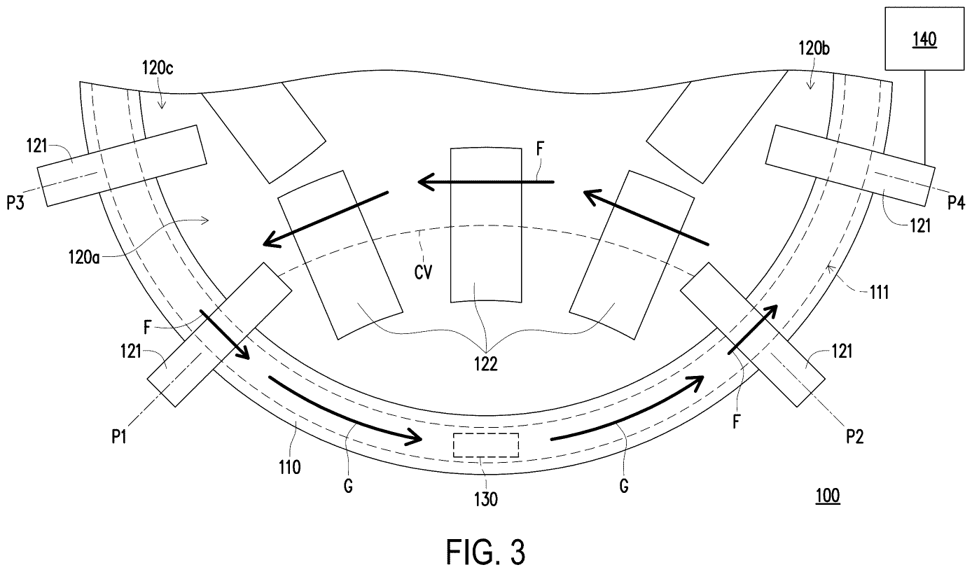

The coil assembly 120a will be taken as an example to illustrate the overall magnetic field formed by the first coils 121 and the second coils 122 as follows. FIG. 3 is a partially enlarged schematic view of the electromagnetic reaction wheel of FIG. 1. Note that the chamber 111 and the magnetic assembly 130 in FIG. 3 are schematically drawn with dotted lines.

Referring to FIG. 3, the first coils 121 and the second coils 122 in this embodiment are arranged along a virtual arc line CV to form a curved Halbach array, which is equivalent to a part of a Halbach quadrupole.

As illustrated in FIG. 3, the first coils 121 and the second coils 122 are electromagnets, each of which has a magnetic field direction F after being energized. Specifically, in this embodiment, the magnetic field directions F of the first coils 121 and the second coils 122 are counterclockwise. In another embodiment, the magnetic field direction F of the first coils 121 and the second coils 122 are clockwise.

In this embodiment, the magnetic assembly 130 is movably disposed in the chamber 111 of the annular tube 110. When the first coils 121 and the second coils 122 are arranged in Halbach array sequence as described above, the induced magnetic field is characterized by a magnetic field direction G along a first direction D1 of the annular tube 110 (i.e., the circumferential direction of the annular tube 110), and the magnetic assembly 130 located between the two first coils 121 (e.g., the first coils 121 at position P1 and position P2) may move relative to the annular tube 110 in the chamber 111, along the magnetic field direction G under the influence of the magnetic field. This motion generates angular momentum resulting in a reaction force on the satellite, leads to an opposite movement of the satellite, and thus achieves attitude adjustment of the satellite in the space environment.

It is worth noting that, if the second coils 122 were not included in the electromagnetic reaction wheel 100 (i.e., only the first coils 121 included), the magnetic assembly 130 would still be able to move under the influence of the magnetic field induced by the first coils 121. In such design, however, if the magnetic assembly 130 previously stops between the two first coils 121 at position P1 and position P2, especially at the intermediate position (e.g., the position where the magnetic assembly 130 is located in FIG. 3) equidistant from the two first coils 121, it may be difficult to drive the magnetic assembly 130 to restart after the first coils 121 are energized, or an increased current supply to the first coils 121 may be required to drive the magnetic assembly 130 to restart, due to this intermediate position least susceptible to the magnetic field of the first coils 121.

In contrast, the design of this disclosure adopts a combination of the first coils 121 and the second coils 122 to form a Halbach array that enhances overall magnetic field intensity and magnetic gradient. As such, even if the magnetic assembly 130 stops at the intermediate position between the two first coils 121, the magnetic assembly 130 may be easily driven and moves again under the influence of this enhanced magnetic field.

Furthermore, compared to the non-Halbach array design, the electromagnetic reaction wheel 100 in this embodiment may generate a stronger magnetic field, given the same current and total number of coil turns, and thus the magnetic assembly 130 may move more forcefully in the chamber 111. In addition, the design of the disclosure does not require an increase in the total number of coil turns to boost magnetic field intensity, thereby saving manufacturing and operational costs, avoiding an increase in overall weight, and enhancing the suitability of the electromagnetic reaction wheel 100 for deployment in a small satellite such as a CubeSat.

In this embodiment, the magnetic field generated by the second coils 122 contributes to the alignment of the magnetic field direction G within the annular tube 110, such that it approximates the first direction D1 of the annular tube 110 and facilitates the smooth movement of the magnetic assembly 130 between the two first coils 121 in the same coil assembly (e.g., the coil assembly 120a). In other words, the second coils 122 serves to guide the magnetic assembly 130.

In addition, compared to a general Halbach array composed of permanent magnets, the Halbach array in this embodiment is composed of electromagnets (i.e., the first coils 121 and the second coils 122). Therefore, the magnitude and the direction of the magnetic field generated by the Halbach array may be modified by changing the current on each coil, thereby enabling flexible adjustment of the magnetic field.

In addition, as described above, the Halbach array in this embodiment is equivalent to a part of the Halbach quadrupole.

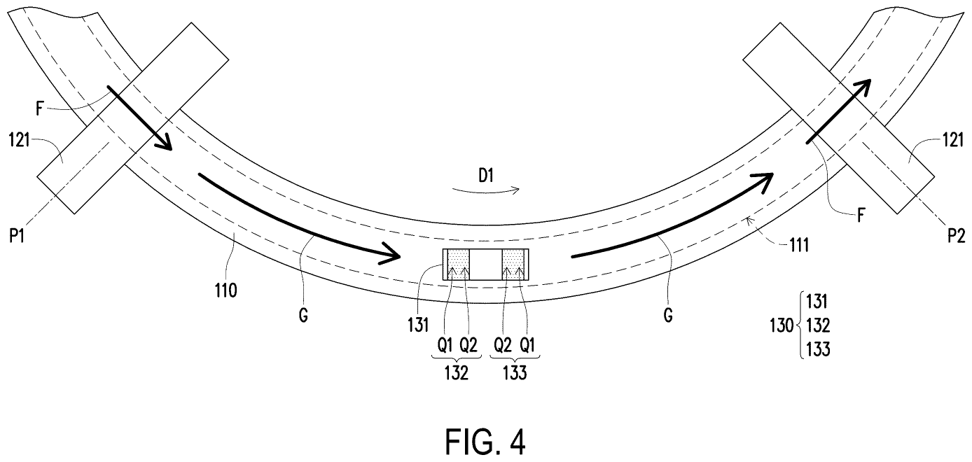

The operation of the electromagnetic reaction wheel 100 will be specifically illustrated as follows. FIG. 4 is a partially enlarged schematic view of the electromagnetic reaction wheel of FIG. 3. To clearly demonstrate the first coils 121 and the magnetic assembly 130, the second coils 122 are hidden in FIG. 4.

Referring to FIG. 3 and FIG. 4, the control unit 140 in this embodiment is electrically connected to each of the coil assemblies 120a, 120b, 120c and is adapted to control the first coils 121 and/or the second coils 122 to be energized or de-energized, so as to drive the magnetic assembly 130 to move relative to the annular tube 110 in the chamber 111. While the control unit 140 is schematically illustrated as connected to the first coil 121 at position P4 in FIG. 3, it should be understood that the control unit 140 is electrically connected to each of the first coils 121 and each of the second coils 122.

In this embodiment, the control unit 140 may be a microprocessor or a microcontroller such as STM32, but the type of the control unit 140 is not limited thereto.

In this embodiment, the magnetic assembly 130 includes a housing 131 (FIG. 4) and two magnetic pole groups 132 and 133 (FIG. 4). The two magnetic pole groups 132 and 133 are disposed in the housing 131. Each of the magnetic pole groups 132 and 133 includes a first magnetic pole Q1 and a second magnetic pole Q2 being opposite in magnetic polarity. The first magnetic pole Q1 is, for example, a pole of North, and the second magnetic pole Q2 is, for example, a pole of South. The first magnetic pole Q1 and the second magnetic pole Q2 are arranged along the first direction D1. The first magnetic poles Q1 of the magnetic pole groups 132 and 133 are distant from each other, and the second magnetic poles Q2 of the magnetic pole groups 132 and 133 are adjacent to each other.

When the magnetic assembly 130 is located between two first coils 121 (e.g., the first coils 121 at position P1 and position P2) of the same coil assembly (e.g., the coil assembly 120a), the control unit 140 may control the first coils 121 and the second coils 122 to be energized. At this time, since the magnetic field directions F of the first coils 121 at position P1 and position P2 are counterclockwise, the first magnetic pole Q1 of the magnetic pole group 132 repels the first coil 121 at position P1, and the first magnetic pole Q1 of the magnetic pole group 133 is attracted by the first coil 121 at position P2. Therefore, the magnetic assembly 130 may move along the magnetic field direction G (i.e., the counterclockwise direction) under the influence of the magnetic field.

As depicted in FIG. 3, when the magnetic assembly 130 approaches the first coil 121 at position P2, the control unit 140 may control the first coil 121 at position P2 to be de-energized, so that the magnetic assembly 130 may smoothly pass through that first coil 121 without experiencing an attractive force that could impede its motion.

When the magnetic assembly 130 passes through the first coil 121 at position P2 and is located between the first coils 121 at position P2 and position P4 (i.e., the two adjacent first coils 121 from the coil assemblies 120a and 120b, respectively), the first coil 121 at position P2 may be energized so that the magnetic assembly 130 is repelled and moves toward the first coil 121 at position P4. In another embodiment, when the magnetic assembly 130 is located between the first coils 121 at position P2 and position P4, the first coil 121 at position P2 is not energized, and the magnetic assembly 130 is still able to move toward the first coil 121 at position P4 by the magnetic force previously applied by the coil assembly 120a.

Similarly, in this embodiment, when the magnetic assembly 130 has not passed through the first coil 121 at position P1 and is located between the first coils 121 at position P3 and position P1, the first coil 121 at position P3 may be energized so that the magnetic assembly 130 is repelled and moves toward the first coil 121 at position P1. In another embodiment, when the magnetic assembly 130 is located between the first coils 121 at position P3 and position P1, the first coil 121 at position P3 is not energized, and the magnetic assembly 130 is still able to move toward the first coil 121 at position P1 by the magnetic force previously applied by the coil assembly 120c.

In addition, after the magnetic assembly 130 passes through the first coil 121 at position P2, the second coils 122 that were previously energized can be de-energized, so as to save power.

In this embodiment, when the magnetic assembly 130 passes through the first coil 121 at position P4 and is located between the two first coils 121 of the coil assembly 120b, the control unit 140 may control the first coils 121 and the second coils 122 of the coil assembly 120b to be energized, so as to generate a magnetic field to drive the magnetic assembly 130 to continue moving, as previously described with respect to the control of the coil assembly 120a.

Similarly, when the magnetic assembly 130 is located between the two first coils 121 of the coil assembly 120c, the control unit 140 may control the first coils 121 and the second coils 122 of the coil assembly 120c to be energized to generate a magnetic field similar to the previously described magnetic field. Furthermore, in this embodiment, when one coil assembly (e.g., the coil assembly 120a) is energized, the coils of the other two coil assemblies 120 (e.g., the coil assemblies 120b, 120c) except for particular first coils 121 may remain de-energized, thereby saving more power.

In addition, in this embodiment, the first coils 121 and the second coils 122 of each of the coil assemblies 120a, 120b, 120c may be supplied with the same or different currents based on actual needs, so as to generate appropriate magnetic fields to drive the magnetic assembly 130 to move.

To induce motion of the magnetic assembly 130 in opposition to the first direction D1, a reverse current may be applied to the coils. This, in other words, generates a magnetic field whose direction is opposite to the magnetic field direction G shown in FIG. 4, thereby propelling the magnetic assembly 130 in the resultant magnetic field direction (i.e., the clockwise direction).

To stop the magnetic assembly 130, the control unit 140 may control all of the coils (i.e., the first coils 121 and the second coils 122) to be de-energized in the electromagnetic reaction wheel 100. In the absence of a magnetic field, the magnetic assembly 130 will decelerate and eventually come to rest due to the dissipation of kinetic energy. Alternatively, the control unit 140 may permit energization of only one first coil 121, with all the other coils in a de-energized state, so that the moving magnetic assembly 130 may be rapidly drawn to the energized first coil 121 and stop its movement.

In addition, only one magnetic assembly 130 is included in this embodiment. In another embodiment, two magnetic assemblies 130 are included to provide higher angular momentum. Of course, the number of the magnetic assemblies 130 is not limited thereto. Moreover, in another embodiment, the magnetic assembly 130 is, for example, a steel ball that is made of a soft magnetic material.

As previously described, the design of the disclosure adopts a Halbach array formed by electromagnets to generate a specific magnetic field direction G along the annular tube 110, so as to drive the magnetic assembly 130 to move in the chamber 111 of the annular tube 110. This configuration generates sufficient angular momentum that results in a reaction force on the satellite and leads to an opposite movement of the satellite, thereby achieving effective attitude adjustment of the satellite in the space environment.

It is worth mentioning that the electromagnetic reaction wheel 100 in this embodiment does not include any flywheel and bearing structure and thus avoids issues such as structural vibration, operational instability, and diminished control precision caused by the wear of bearings found in conventional reaction wheels, providing extended product lifespan and excellent operational stability.

In addition, in this embodiment, the magnetic assembly 130 of the electromagnetic reaction wheel 100 moves on only one plane where the annular tube 110 is located (i.e., the plane of the paper). To realize three-axis attitude adjustment, three electromagnetic reaction wheels 100 are required to be installed in the host satellite, and the planes where the electromagnetic reaction wheels 100 are located are orthogonal to each other.

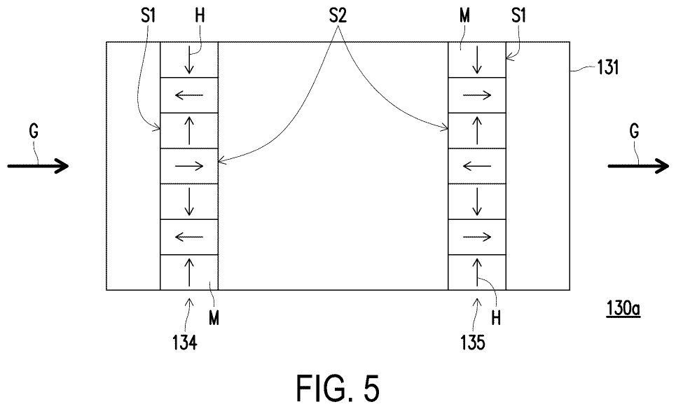

FIG. 5 is a schematic view of a magnetic assembly according to another embodiment of the disclosure. A main difference between the embodiment shown in FIG. 5 and the embodiment shown in FIG. 4 is that the magnetic assembly 130a adopts a different design in FIG. 5.

Specifically, the magnetic assembly 130a includes a housing 131 and two magnet groups 134 and 135. The two magnet groups 134 and 135 are disposed in the housing 131, and each of them includes a plurality of magnets M. The magnets M of each of the magnet groups 134 and 135 are arranged to form a linear Halbach array. The linear Halbach array has a strong side S1 and a weak side S2. The magnetic field intensity of the strong side S1 is much greater than the magnetic field intensity of the weak side S2.

For the magnet group 134 in FIG. 5, the magnetic field directions H of the magnets M, from top to bottom, for example, are oriented as follows: bottomward, leftward, upward, rightward, bottomward, leftward, and upward, respectively. The strong side S1 may be formed on the left side of the magnet group 134, and a weak side S2 may be formed on the right side of the magnet group 134.

On the other hand, for the magnet group 135, the magnetic field directions H of the magnets M, from top to bottom, for example, are oriented as follows: bottomward, rightward, upward, leftward, bottomward, rightward, and upward, respectively. The strong side S1 may be formed on the right side of the magnet group 135, and the weak side S2 may be formed on the left side of the magnet group 135. In this way, the strong sides S1 of the magnet groups 134 and 135 are distant from each other, and the weak sides S2 of the magnetic pole groups 134 and 135 are adjacent to each other.

Similar to the embodiment shown in FIG. 4, when the magnetic assembly 130a in this embodiment is located between two first coils 121 (FIG. 4) of the same coil assembly (e.g., the coil assembly 120a of FIG. 4), the strong side S1 of the magnet group 134 repels the adjacent first coil 121, and the strong side S1 of the magnet group 135 is attracted by another adjacent first coil 121. Therefore, the magnetic assembly 130a may move along the magnetic field direction G under the influence of the magnetic field, generate appropriate angular momentum, and achieve attitude adjustment of the satellite in the space environment.

Moreover, seven magnets M are included in each of the magnet groups 134 and 135 in this embodiment, but the number of magnets M is not limited thereto, so long as it is sufficient to form a linear Halbach array.

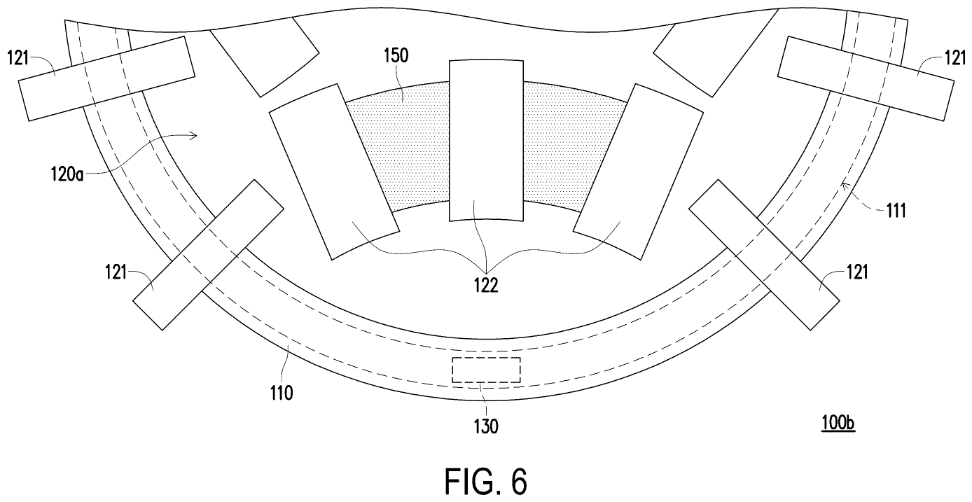

FIG. 6 is a partially enlarged schematic view of an electromagnetic reaction wheel according to another embodiment of the disclosure. A main difference between the embodiment shown in FIG. 6 and the embodiment shown in FIG. 4 is that the electromagnetic reaction wheel 100b further includes a core body 150 in FIG. 6.

Specifically, the core body 150 in this embodiment is disposed inside the second coils 122 of the same coil assembly (e.g., coil assembly 120a), allowing the core body 150 to be magnetized to strengthen the magnetic field. The magnetic flux density at the middle position (e.g., the position of the magnetic assembly 130 in FIG. 6) between the two first coils 121 may be enhanced to 328.6%, for example.

Moreover, the core body 150 is made of soft magnetic material, preferably ferrite or steel lamination. In the case where copper and ferrite are adopted as the materials of the coils and the core body 150, respectively, the addition of the ferrite core body 150 reduces the average mass density of the electromagnetic reaction wheel 100b by, for example, 28.6%, due to the fact that the mass density of ferrite is lower than the mass density of copper. In other words, in this embodiment, the electromagnetic reaction wheel 100b exhibits a reduced average mass density with enhanced magnetic field intensity and magnetic gradient, thereby demonstrating superior magnetic field performance. The remaining components and configuration of the electromagnetic reaction wheel 100b are identical as or similar to those of the electromagnetic reaction wheel 100 and will not be reiterated here.

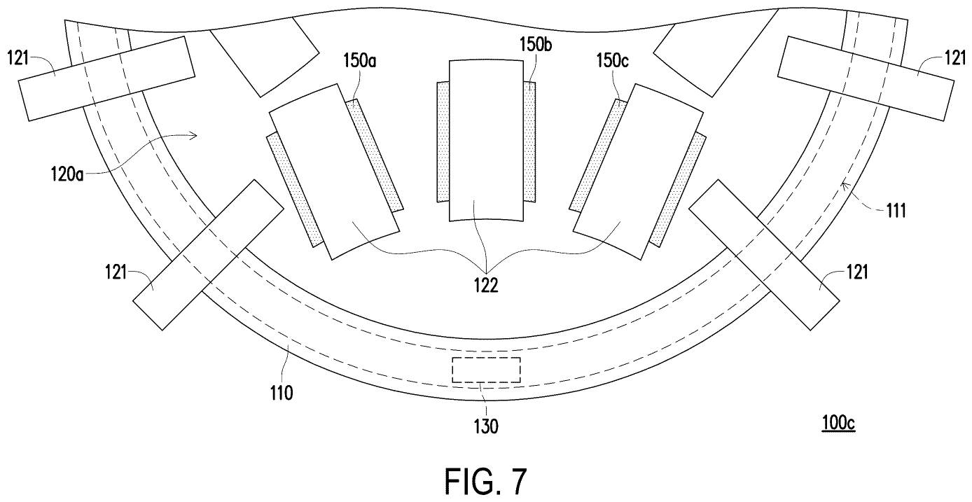

FIG. 7 is a partially enlarged schematic view of an electromagnetic reaction wheel according to another embodiment of the disclosure. A main difference between the embodiment shown in FIG. 7 and the embodiment shown in FIG. 6 is that the electromagnetic reaction wheel 100c further includes a plurality of core bodies 150a, 150b, and 150c in FIG. 7.

Specifically, the core bodies 150a, 150b, 150c are respectively inserted into the three second coils 122 of the same coil assembly (e.g., the coil assembly 120a), allowing the core bodies 150a, 150b, 150c to be magnetized to further strengthen the magnetic field. Additionally, three core bodies are included in this embodiment, but the number of core bodies is not limited thereto, as long as it corresponds to the number of the second coils 122. The remaining components and configuration of the electromagnetic reaction wheel 100c are identical or similar to those of the aforementioned electromagnetic reaction wheels 100 and 100b and will not be reiterated here.

In summary, the electromagnetic reaction wheel of the disclosure includes an annular tube, a plurality of coil assemblies, a magnetic assembly, and a control unit. The first coils and the second coils in each of the coil assemblies are arranged in Halbach array sequence to generate a magnetic field with a direction along the circumference of the annular tube. By appropriately controlling the first coils and/or the second coils to be energized or deenergized, the control unit may drive the magnetic assembly to move smoothly relative to the annular tube in the chamber of the annular tube, thereby enabling appropriate angular momentum generation and effective attitude adjustment of the host spacecraft such as a satellite. The elimination of structures such as a flywheel and bearings in the electromagnetic reaction wheel avoids issues associated with bearing wear, thereby providing an extended operational lifespan and enhanced operational stability.

In addition, by forming a Halbach array with the first coils and the second coils, the magnetic field intensity and magnetic gradient of the electromagnetic reaction wheel may be enhanced, without increasing the current or total number of coil turns, and allow the magnetic assembly at any position within the annular tube to be easily actuated and move smoothly, thereby saving manufacturing and operating costs and avoiding an increase in overall weight. Meanwhile, the Halbach array is formed by electromagnets, and thus the density and the direction of the magnetic field is adjustable by changing the coil current, enabling flexible adjustment of the magnetic field.

In addition, the electromagnetic reaction wheel of the disclosure may further include a core body disposed in the second coils, which further strengthens the magnetic field and reduces the average mass density of the electromagnetic reaction wheel, thereby providing excellent magnetic field performance.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An electromagnetic reaction wheel, comprising:
an annular tube, having a chamber;
a plurality of coil assemblies, each of the plurality of coil assemblies comprising:
a plurality of first coils, disposed on an outer surface of the annular tube; and
a plurality of second coils, distant from the annular tube, wherein the plurality of first coils and the plurality of second coils are arranged in Halbach array sequence;
a magnetic assembly, movably disposed in the chamber of the annular tube; and
a control unit, electrically connected to the coil assemblies, wherein the control unit is adapted to control the plurality of first coils and/or the plurality of second coils to be energized or de-energized, so as to drive the magnetic assembly to move relative to the annular tube in the chamber.

2. The electromagnetic reaction wheel according to claim 1, wherein the plurality of second coils are disposed between a center of the annular tube and the annular tube.

3. The electromagnetic reaction wheel according to claim 1, wherein the plurality of first coils comprise two first coils, and the plurality of second coils are located between the two first coils.

4. The electromagnetic reaction wheel according to claim 1, wherein the plurality of first coils and the plurality of second coils are arranged along a virtual arc line.

5. The electromagnetic reaction wheel according to claim 1, further comprising a core body, wherein the core body is made of soft magnetic material and passes through the plurality of second coils.

6. The electromagnetic reaction wheel according to claim 1, further comprising a plurality of core bodies, wherein the plurality of core bodies are made of soft magnetic material and are respectively disposed inside the plurality of second coils.

7. The electromagnetic reaction wheel according to claim 1, wherein the magnetic assembly comprises two magnetic pole groups, each of the two magnetic pole groups comprises a first magnetic pole and a second magnetic pole being opposite in magnetic polarity, the first magnetic pole and the second magnetic pole are arranged along a first direction, the first magnetic pole of each of the two magnetic pole groups is distant from each other, and the second magnetic pole of each of the two magnetic pole groups is adjacent to each other.

8. The electromagnetic reaction wheel according to claim 1, wherein the magnetic assembly comprises two magnet groups, each of the two magnet groups comprises a plurality of magnets, the plurality of magnets are arranged in Halbach array sequence, a strong side of each of the two magnet groups is distant from each other, and a weak side of each of the two magnet groups is adjacent to each other.

9. The electromagnetic reaction wheel according to claim 1, wherein the plurality of second coils comprise at least three second coils.

10. The electromagnetic reaction wheel according to claim 1, wherein the plurality of coil assemblies comprise at least three coil assemblies.
